(19) United States
(12) Patent Application Publication
(10) Pub. No.: US 2013/0309501 A1
(43) Pub. Date: Nov. 21, 2013

(54) METHOD FOR PRODUCING CARBON MEMBER-INORGANIC MEMBER JOINED BODY, AND CARBON MEMBER-INORGANIC MEMBER JOINED BODY

(71) Applicant: TOYO TANSO CO., LTD., Osaka (JP)

(72) Inventors: Tomoyuki OHKUNI, Osaka-shi (JP); Weiwu CHEN, Suita-shi (JP); Yoshinari MIYAMOTO, Osaka-shi (JP)

(73) Assignee: TOYO TANSO CO., LTD., Osaka (JP)

(21) Appl. No.: 13/675,430

(22) Filed: Nov. 13, 2012

(30) Foreign Application Priority Data
May 15, 2012 (JP) 2012-111811
Sep. 4, 2012 (JP) 2012-194136

(51) Int. Cl. C04B 35/64; B05D 3/02

(52) U.S. Cl. CPC C04B 35/64; B05D 3/0254
USPC 428/408; 427/372.2; 427/374.1; 427/397.7; 427/58

(57) ABSTRACT

Provided is a method for producing a novel carbon member-inorganic member joined body. A carbon member-inorganic member joined body including a carbon member and an inorganic member joined together is produced. The carbon member-inorganic member joined body is obtained by forming on the carbon member a layer containing an inorganic material and a sintering aid, and heating the layer.

### BACKGROUND OF THE INVENTION

1. Field of the Invention

The present invention relates to a method for producing a carbon member-inorganic member joined body, and to a carbon member-inorganic member joined body.

2. Description of the Related Art

Carbon members do not have a melting point at normal pressure. Ceramics generally have a high melting point. Unlike other metals, a refractory metal such as W or Mo is produced by a sintering method rather than by a melting method because it has a very high melting point. Therefore, it would be difficult to join a carbon member and an inorganic member such as ceramics or a refractory metal by a fusion welding method.

Carbon members and ceramics are generally fragile materials. As also for the aforementioned refractory metal, it is difficult to join a carbon member and such an inorganic member by pressure welding because of its high melting point. For this reason, the joint between a carbon member and such an inorganic member is achieved by a mechanical method using a screw or the like, or by a method using solder, an adhesive or the like.

For example, JP-A-H06-345553 discloses an adhesion method for a graphite member using a phenol/formaldehyde resin. JP-A-2002-321987 discloses adhesion of a graphite member using a carbon-based adhesive such as a phenol resin. JP-A-H04-26567 discloses a method for joining graphite and an aluminum-based material using solder.

### SUMMARY OF THE INVENTION

However, with a method of using an adhesive of an organic substance, for example, it is difficult to produce a carbon member-inorganic member joined body that is used for the application where it is heated at high temperature. Also in a method of carbonizing the adhesive as described above, there is a fear that the heat conductivity is impaired by the carbonizied adhesive. Also in the case where solder is used, the resultant carbon member-inorganic member joined body cannot be used at a temperature higher than or equal to the melting point of the solder, and it is difficult to produce a carbon member-inorganic member joined body that is used for the application where it is heated at high temperature. Under such a circumstance, a more effective method for joining a carbon member and an inorganic member has been demanded.

It is a primary object of the present invention to provide a method for producing a novel carbon member-inorganic member joined body.

The production method according to the present invention is a method for producing a carbon member-inorganic member joined body including a carbon member and an inorganic member joined together. In the production method according to the present invention, the carbon member-inorganic member joined body is obtained by forming on the carbon member a layer containing an inorganic material and a sintering aid, and heating the layer.

In the method for producing a carbon member-inorganic member joined body according to the present invention, it is preferred to use, as the sintering aid, at least one kind selected from the group consisting of yttrium oxide, aluminum oxide, calcium oxide, lithium oxide, silicon oxide, boron oxide, zirconium oxide, magnesium oxide, cerium oxide, gadolinium oxide, europium oxide, lanthanum oxide, lutetium oxide, neodymium oxide, erbium oxide, dysprosium oxide and samarium oxide.

In the method for producing a carbon member-inorganic member joined body according to the present invention, it is preferred to allow the sintering aid to remain in a superficial layer of the carbon member by allowing the sintering aid to enter recesses or pores of the superficial layer of the carbon member by heating, followed by cooling.

In the method for producing a carbon member-inorganic member joined body according to the present invention, it is preferred that silicon element is contained in the ceramics and/or the sintering aid, and a crystal phase or an amorphous glass phase is formed in the interface between the carbon member and the ceramics by the sintering.

In the method for producing a carbon member-inorganic member joined body according to the present invention, it is preferred that a content of the sintering aid in the layer containing the inorganic material and the sintering aid is greater than or equal to 2% by mass.

In the method for producing a carbon member-inorganic member joined body according to the present invention, it is preferred to use, as the inorganic material, at least one kind selected from the group consisting of a carbon material, a silicon material, a metal material and a glass material.

In the method for producing a carbon member-inorganic member joined body according to the present invention, it is preferred to use, as the carbon member, at least one kind selected from the group consisting of an electrode member for steelmaking, an isotropic graphite member, a porous carbon member, a carbon fiber assembly, a carbon fiber composite material, and a carbon fiber reinforced carbon composite material.

A first carbon member-inorganic member joined body according to the present invention includes a carbon member and an inorganic member. The inorganic member is joined with the carbon member. A sintering aid is contained both in a superficial layer on the side of the inorganic member in the carbon member and in a superficial layer on the side of the carbon member in the inorganic member.

In the first carbon member-inorganic member joined body according to the present invention, a content of the sintering aid in the superficial layer on the side of the inorganic member in the carbon member may be larger than that of the sintering aid on the side of the carbon member in the inorganic member.

A second carbon member-inorganic member joined body according to the present invention includes a carbon member and a ceramic member joined with the carbon member. A crystal phase or an amorphous glass phase formed by sintering is provided in joint interface between the carbon member and the ceramic member.

According to the present invention, it is possible to provide a method for producing a novel carbon member-inorganic member joined body.

### BRIEF DESCRIPTION OF THE DRAWINGS

FIG. 1 is a schematic cross-sectional view for illustrating a method for producing a carbon member-inorganic member joined body according to one embodiment of the present invention.

FIG. 2 is a schematic cross-sectional view of a carbon member-inorganic member joined body according to one embodiment of the present invention.

FIG. 3 is a SEM image of an interface part between a carbon member and an inorganic member in a carbon member-inorganic member joined body A obtained in Example 1.

FIG. 4 is a SEM image showing distribution of Al element in the interface part between the carbon member and the inorganic member in the carbon member-inorganic member joined body A obtained in Example 1.

FIG. 5 is a SEM image showing distribution of C element in the interface part between the carbon member and the inorganic member in the carbon member-inorganic member joined body A obtained in Example 1.

FIG. 6 is a SEM image showing distribution of Y element in the interface part between the carbon member and the inorganic member in the carbon member-inorganic member joined body A obtained in Example 1.

FIG. 7 is a SEM image of an interface part between a carbon member and an inorganic member in a carbon member-inorganic member joined body B obtained in Example 2.

FIG. 8 is a SEM image showing distribution of Al element in the interface part between the carbon member and the inorganic member in the carbon member-inorganic member joined body B obtained in Example 2.

FIG. 9 is a SEM image showing distribution of C element in the interface part between the carbon member and the inorganic member in the carbon member-inorganic member joined body B obtained in Example 2.

FIG. 10 is a SEM image showing distribution of Y element in the interface part between the carbon member and the inorganic member in the carbon member-inorganic member joined body B obtained in Example 2.

FIG. 11 is a SEM image of an interface part between a carbon member and a ceramic member in a carbon member-inorganic member joined body E obtained in Example 5.

FIG. 12 is a SEM image of an interface part between a carbon member and a ceramic member in a carbon member-inorganic member joined body H obtained in Comparative Example 2.

FIG. 13 is a graph showing peak intensities of X-ray diffraction in the interface parts of carbon member-inorganic member joined bodies D to F obtained in Examples 4 to 6.

FIG. 14 is a SEM image showing distribution of Si element in the interface part between a carbon member and an inorganic member in the carbon member-inorganic member joined body D obtained in Example 4.

FIG. 15 is a SEM image showing distribution of Al element in the interface part between the carbon member and the inorganic member in the carbon member-inorganic member joined body D obtained in Example 4.

FIG. 16 is a SEM image showing distribution of Y element in the interface part between the carbon member and the inorganic member in the carbon member-inorganic member joined body D obtained in Example 4.

FIG. 17 is a SEM image showing distribution of Si element in the interface part between a carbon member and an inorganic member in the carbon member-inorganic member joined body F obtained in Example 6.

FIG. 18 is a SEM image showing distribution of Al element in the interface part between the carbon member and the inorganic member in the carbon member-inorganic member joined body F obtained in Example 6.

FIG. 19 is a SEM image showing distribution of Y element in the interface part between the carbon member and the inorganic member in the carbon member-inorganic member joined body F obtained in Example 6.

### DETAILED DESCRIPTION OF THE PREFERRED EMBODIMENTS

Hereinafter, a preferred embodiment of the present invention will be described. However, the following embodiments are merely illustrative. The present invention is not intended to be limited to the following embodiments.

The drawings referred in the embodiments and the like are schematically illustrated, and a ratio of dimension and the like of an object depicted in the drawing may be different from those of an actual object. A concrete dimensional ratio and the like of an object should be recognized with reference to the following description.

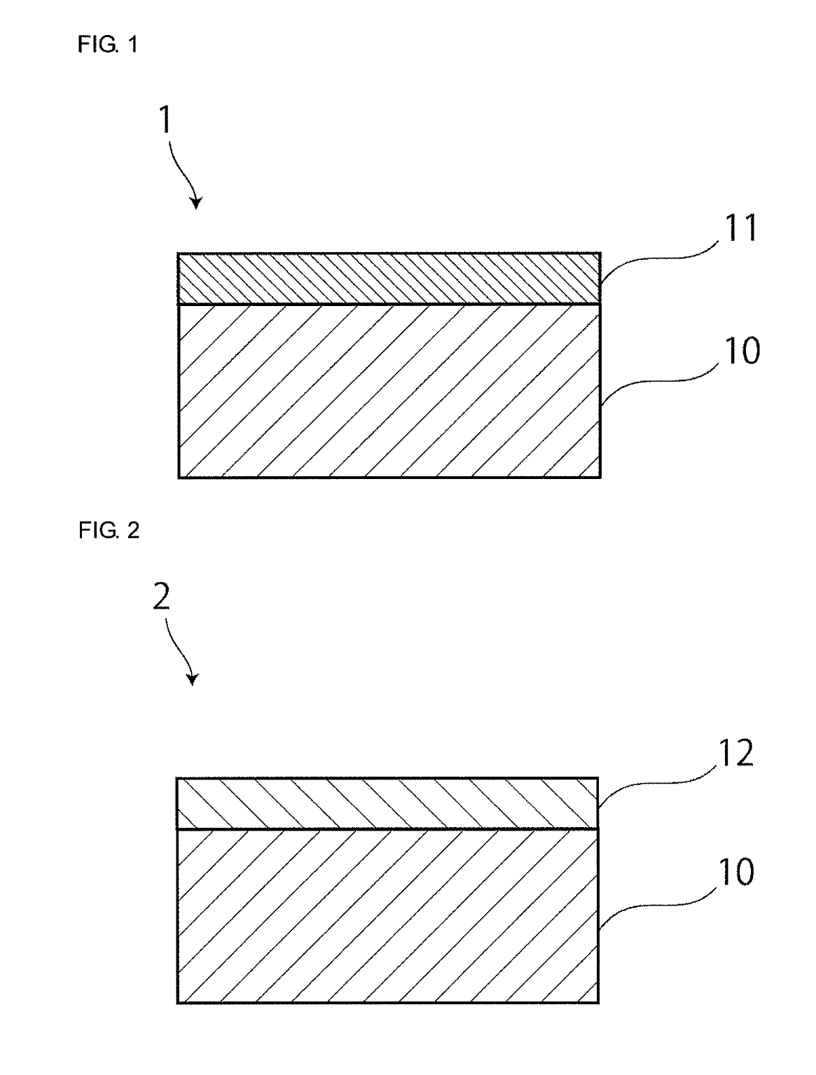

FIG. 1 is a schematic cross-sectional view for illustrating a method for producing a carbon member-inorganic member joined body in the present embodiment. FIG. 2 is a schematic cross-sectional view showing the carbon member-inorganic member joined body in the present embodiment. With reference to FIG. 1 and FIG. 2, a method for producing a carbon member-inorganic member joined body 2 in the present embodiment and a constitution of the same will be described.

(Method for Producing Carbon Member-Inorganic Member Joined Body 2)

In the method for producing the carbon member-inorganic member joined body 2, first, a carbon member 10 shown in FIG. 1 is prepared.

The carbon member 10 is not particularly limited insofar as it includes carbon as a main component. As the carbon member 10, at least one kind selected from the group consisting of an electrode member for steelmaking, an isotropic graphite member, a porous carbon member, a carbon fiber assembly, a carbon fiber composite material, and a carbon fiber reinforced carbon composite material is preferably used. The carbon member may be either carbonaceous or graphite. A shape of the carbon member 10 is not particularly limited.

Next, on the carbon member 10, an inorganic material layer 11 containing an inorganic material and a sintering aid is formed, to obtain a carbon member-inorganic material laminate 1. The inorganic material layer 11 is formed of a mixture of an inorganic material and a sintering aid. The inorganic material layer 11 may be, for example, a mixture of inorganic material particles and sintering aid particles, or may be a plate-like inorganic material where a sintering aid is dispersed. The inorganic material layer 11 may contain other components than the inorganic material and the sintering aid.

The kind of the inorganic material is not particularly limited. As the inorganic material, it is preferred to use at least one kind selected from the group consisting of a carbon material, a silicon material, a metal material, ceramics, and a glass material.

As the carbon material, it is preferred to use, for example, an electrode material for steelmaking, an isotropic graphite material, a porous carbon material, a carbon fiber assembly, a carbon fiber composite material, a carbon fiber reinforced carbon composite material and the like.

As the silicon material, it is preferred to use, for example, single-crystalline silicon, polycrystalline silicon and the like.

As the metal material, it is preferred to use, for example, tungsten, molybdenum, tantalum, ruthenium, rhodium, niobium, hafnium, an alloy containing at least one kind thereof and the like.

As the glass material, it is preferred to use, for example, soda lime grass, crystallized glass and the like.

As the ceramics, it is preferred to use, for example, at least either one of metal nitride and metal carbide. As the ceramics, it is more preferred to use at least one kind selected from the group consisting of aluminum nitride, boron nitride, silicon nitride, silicon carbide, boron carbide, tantalum carbide, zirconium carbide, tungsten carbide, titanium carbide, chromium carbide and niobium carbide.

Next, the carbon member-inorganic material laminate 1 is heated. As a result, the carbon member-inorganic member joined body 2 including the carbon member 10 and an inorganic member 12 joined together as shown in FIG. 2 is obtained.

A method for heating the inorganic material layer 11 is not particularly limited. Examples of the heating method include a spark plasma sintering method, a hot press method, a normal pressure sintering method and the like. The heating temperature is preferably greater than or equal to 1600° C., and more preferably greater than or equal to 1800° C. The heating temperature is normally less than or equal to 2100° C. The pressure at the time of heating is preferably greater than or equal to 1 MPa, and more preferably greater than or equal to 10 MPa. The pressure at the time of heating is normally less than or equal to 40 MPa.

At the time of heating the inorganic material layer 11, at least either one of the sintering aid and a component derived from the sintering aid (hereinafter, also referred to as “sintering aid or the like”) migrates, at least partly, from the inorganic material layer 11 to the carbon member 10. This is attributable to the fact that the sintering aid or the like turns into liquid at elevated temperature under heating, and enters recesses, pores or the like in a superficial layer of the carbon member 10 and the sintering aid or the like solidifies by cooling and remains in the carbon member 10. In other words, in the present embodiment, the sintering aid is allowed to remain in the superficial layer of the carbon member 10 by allowing the sintering aid to enter the recesses or pores in the superficial layer of the carbon member 10 by heating, and cooling the same.

In the present invention, the sintering aid means a sintering aid that is used for sintering ceramics or the like. As the sintering aid, for example, common sintering aids that are used for sintering ceramics may be used. For further strengthening the joint between the carbon member 10 and the inorganic member 12 in the carbon member-inorganic member joined body 2, it is preferred to use, as the sintering aid, at least one kind selected from the group consisting of yttrium oxide, aluminum oxide, calcium oxide, lithium oxide, silicon oxide, boron oxide, zirconium oxide, magnesium oxide, cerium oxide, gadolinium oxide, europium oxide, lanthanum oxide, lutetium oxide, neodymium oxide, erbium oxide, dysprosium oxide and samarium oxide.

For further strengthening the joint between the carbon member 10 and the inorganic member 12, a content of the sintering aid in the inorganic material layer 11 is preferably greater than or equal to 2% by mass, and more preferably greater than or equal to 3% by mass. The content of the sintering aid in the inorganic material layer 11 is preferably less than or equal to 15% by mass, and more preferably less than or equal to 10% by mass.

In the manner as described above, the carbon member-inorganic member joined body 2 can be produced.

(Carbon Member-Inorganic Member Joined Body 2)

As shown in FIG. 2, the carbon member-inorganic member joined body 2 includes the carbon member 10 and the inorganic member 12. The inorganic member 12 is joined with the carbon member 10.

The sintering aid or the like is contained both in a superficial layer on the side of the inorganic member 12 in the carbon member 10 and in a superficial layer on the side of the carbon member 10 in the inorganic member 12. A content of the sintering aid or the like in the superficial layer on the side of the inorganic member 12 in the carbon member 10 is may be sometimes higher than that of the sintering aid or the like on the side of the carbon member 10 in the inorganic member 12. This is attributable to the fact that the sintering aid or the like having turned into liquid at elevated temperature under heating tends to enter recesses, pores or the like in the superficial layer of the carbon member 10 and more likely to remain in the carbon member 10.

In the carbon member-inorganic member joined body 2, the carbon member 10 and the inorganic member 12 are strongly joined. Although the detail of the reason for this is not necessarily clear, for example, the following presumption can be made. As described above, during heating of the inorganic material layer 11, the sintering aid or the like contained in the inorganic material layer 11 turns into liquid, and enters recesses, pores or the like in the superficial layer of the carbon member 10, and then solidifies by cooling. At this time, the sintering aid or the like solidifies in the interface part between the carbon member 10 and the inorganic member 12, so that the carbon member 10 and the inorganic member 12 are joined strongly via the sintering aid or the like.

Further, it is not necessarily required to use solder, an adhesive or the like in the carbon member-inorganic member joined body 2. Therefore, the carbon member-inorganic member joined body 2 may be used at a temperature as high as 1000° C. or higher, for example.

Further, since it is not necessarily required to use solder, an adhesive or the like, a thermal resistance layer is not formed in the carbon member-inorganic member joined body 2. Therefore, the carbon member-inorganic member joined body 2 has excellent heat conductivity.

Hereinafter, the present invention will be described in more detail with reference to specific examples. The present invention is not limited at all by the following examples and can be embodied in various other forms appropriately modified without changing the gist of the invention.

### Example 1

As a carbon member, isotropic graphite having a bulk density of 1.8 Mg/m³, a bending strength of 40 MPa, and a linear thermal expansion coefficient of 4.7×10⁻⁶/K was used. As an inorganic material, aluminum nitride (AlN) powder was used. As a sintering aid, yttrium oxide (Y₂O₃) was used. The inorganic material and the sintering aid were mixed so that the ratio by mass was 95:5, and the resultant mixture was placed on the carbon member to form a laminate. The obtained laminate was heated at about 1900° C. under a pressure of about 30 MPa by a spark plasma sintering method, to prepare a carbon member-inorganic member joined body A.

Then, for the purpose of measuring the joint strength of the carbon member-inorganic member joined body, a tension test was conducted. A triple-layered structure in which inorganic members were joined on and under the aforementioned carbon member in the same manner as described above was prepared. A stainless jig was allowed to adhere to each of the upper and lower inorganic members with an epoxy-based adhesive. The condition for adhesion at this time was retaining at 80° C. for more than or equal to 24 hours. By pulling the stainless jigs fixed to the test piece at 0.5 mm/minute by a strength test machine, joint strength between the graphite member and the inorganic member was measured. As a result, the joint strength was 13 MPa. In the carbon member-inorganic member joined body A, strong joint between the carbon member and the inorganic member was achieved.

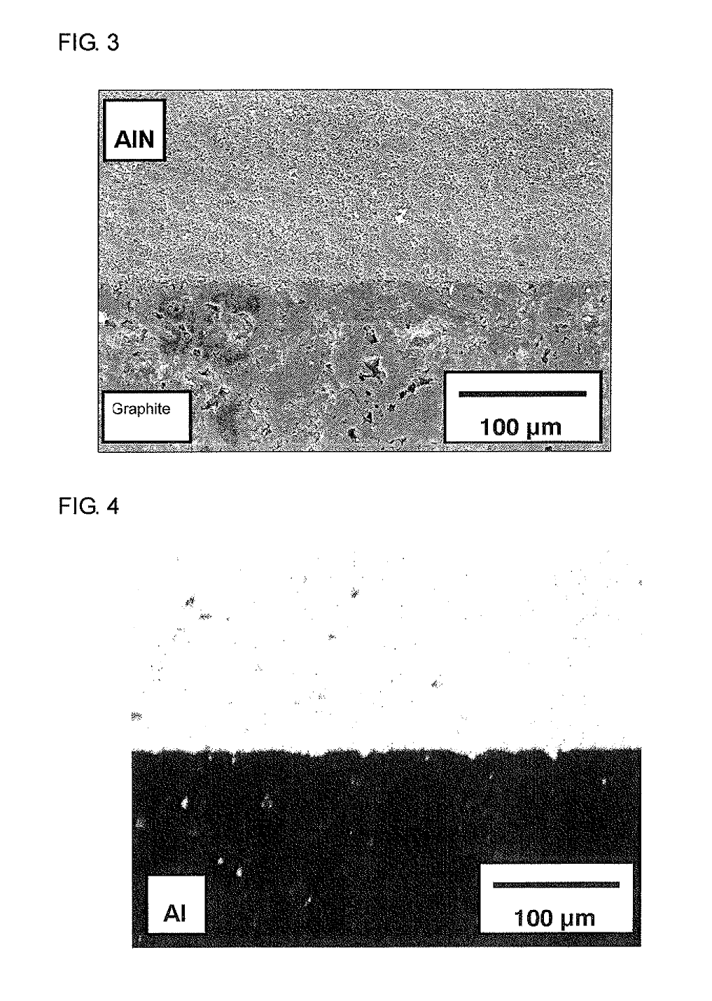

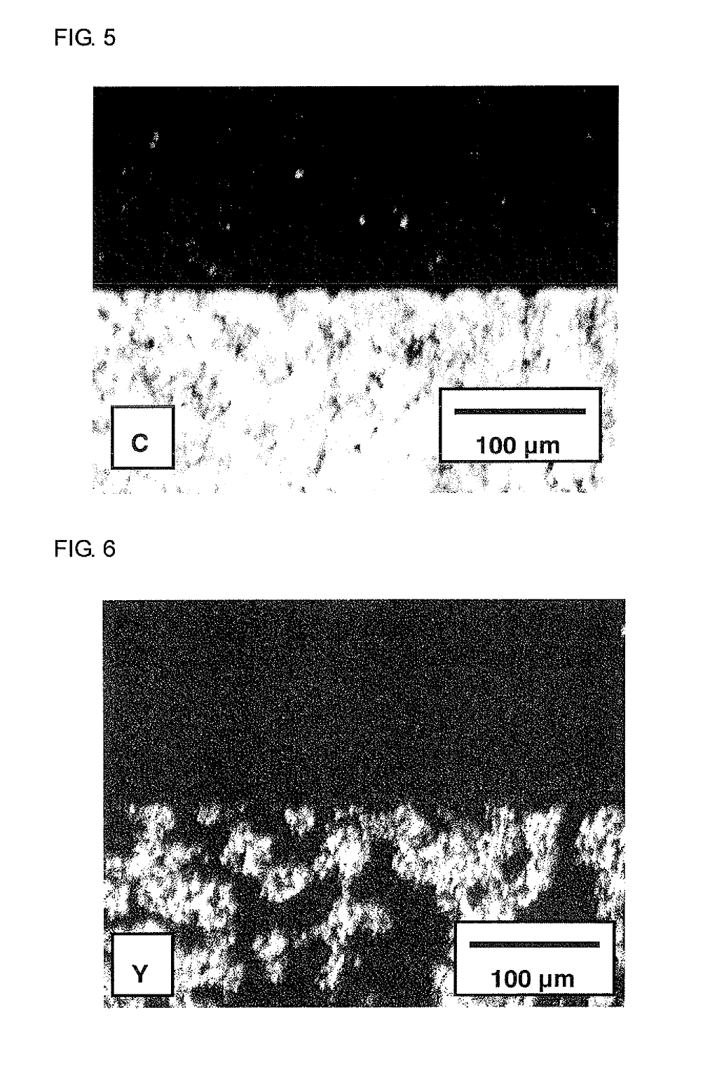

A SEM image of the interface part between the carbon member and the inorganic member in the carbon member-inorganic member joined body A is shown in FIG. 3. Also distributions of Al, C and Y elements are shown in FIG. 4, FIG. 5 and FIG. 6, respectively. As is apparent from FIGS. 3 to 6, it can be found that there is plenty of sintering aid on the side of the carbon member.

### Example 2

A carbon member-inorganic member joined body B was prepared in the same manner as in Example 1 except that an aluminum nitride (AlN) sintered plate containing yttrium oxide (Y₂O₃) was used as the mixture of the inorganic material and the sintering aid.

The joint strength of the carbon member-inorganic member joined body B measured in the same manner as in Example 1 was 10 MPa. In the carbon member-inorganic member joined body B, strong joint between the carbon member and the inorganic member was achieved.

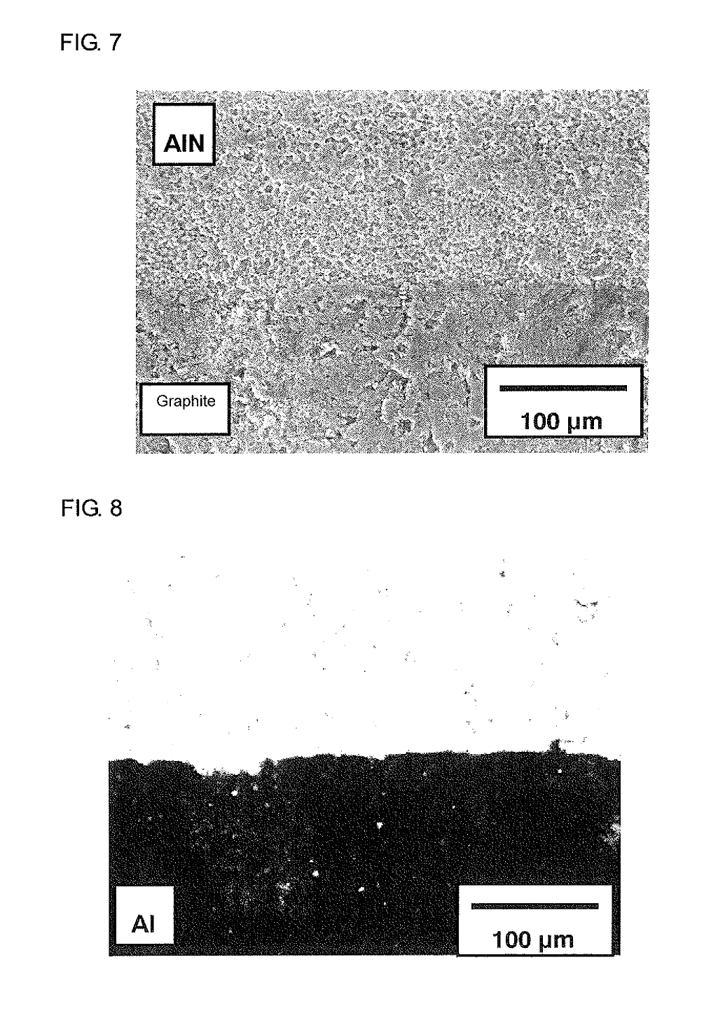

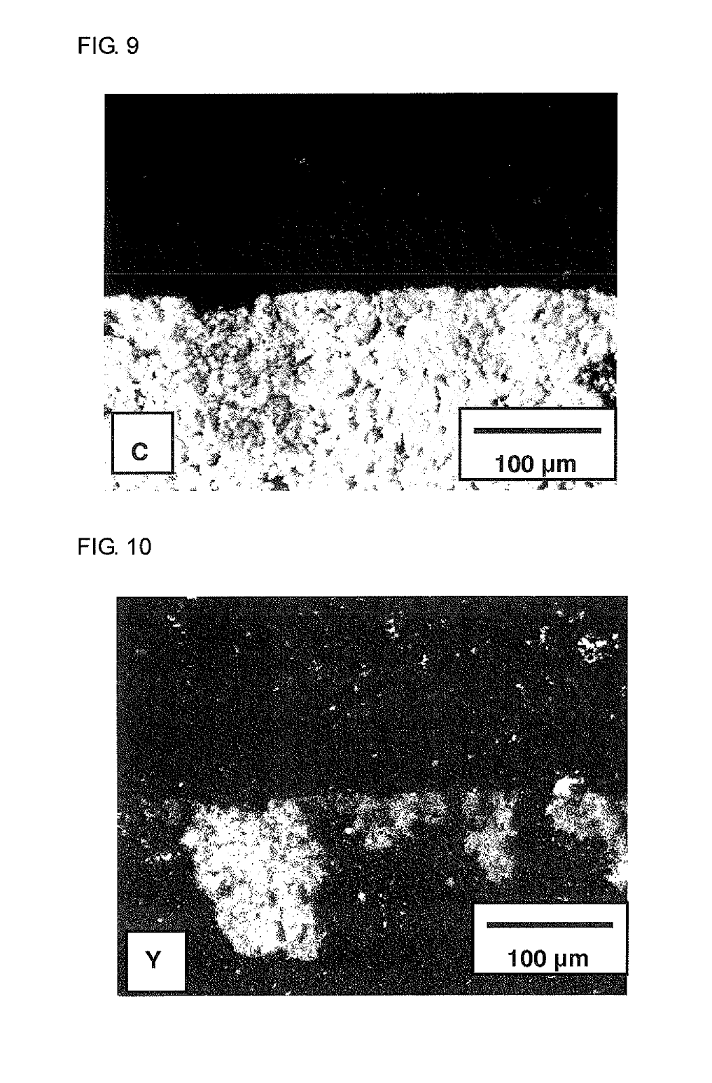

A SEM image of the interface part between the carbon member and the inorganic member in the carbon member-inorganic member joined body B is shown in FIG. 7. Also distributions of Al, C and Y elements are shown in FIG. 8, FIG. 9 and FIG. 10, respectively. As is apparent from FIGS. 7 to 10, it can be found that there is plenty of sintering aid on the side of the carbon member.

### Example 3

Aluminum nitride (AlN) powder (mean particle size 0.6 μm, specific surface area 2.7 m²/g) as an inorganic material and yttrium oxide (Y₂O₃) as a sintering aid were mixed so that the ratio by mass (inorganic material:sintering aid) was 95:5. Then, the resultant mixture was added with 2-ethylhexyl phosphate as a dispersant, a mixture of 2-butanone and ethanol (volume ratio 67:33) as a solvent, polyvinylbutyral as a binder, and a mixture of polyethylene glycol and benzylbutyl alcohol phthalate (mass ratio 50:50) as a plasticizer, and mixed by means of a planetary centrifugal mixer to obtain a slurry. The obtained slurry was applied on a PET film with the use of a doctor blade, and dried to obtain a sheet of 140 μm. A carbon member-inorganic member joined body C was prepared in the same manner as in Example 1 by a spark plasma sintering method except that this sheet was disposed between the carbon member and the aluminum nitride (AlN) sintered plate used in Example 2 to form a laminate.

The joint strength of the carbon member-inorganic member joined body C measured in the same manner as in Example 1 was 14 MPa. In the carbon member-inorganic member joined body C, strong joint between the carbon member and the inorganic member was achieved.

In Examples 1 to 3, the sintering aid melts during sintering or firing, and oozes out in the joint part between the carbon member and the ceramic member, however, it is supposed that a crystal phase of Al₂Y₄O₉ is generated in the joint interface when sintering is conducted while Y₂O₃ or Al₂O₃ is added as a phase sintering aid. It is supposed that the strong joint strength is obtained because this crystal phase allows the carbon member and the ceramic member to exert the anchor effect of cutting into irregularity portions in the surface of the carbon member while filling in a gap of the interface between the carbon member and the ceramic member, in addition to permeation of the sintering aid into the carbon member.

### Example 4

A carbon member-inorganic member joined body D was prepared in the same manner as in Example 1 except that silicon carbide (SiC) powder (mean particle size 0.8 lam, specific surface area 13 to 15 m²/g) was used as the inorganic material, yttrium oxide (Y₂O₃) and aluminum oxide (Al₂O₃) were used as the sintering aid, and they were mixed so that the weight ratio was SiC:Y₂O₃: Al₂O₃=91:3:6, and the temperature in the spark plasma sintering method was 1800° C.

The joint strength of the carbon member-inorganic member joined body D measured in the same manner as in Example 1 was 18 MPa. In the carbon member-inorganic member joined body D, strong joint between the carbon member and the inorganic member was achieved.

### Example 5

A carbon member-inorganic member joined body E was prepared in the same manner as in Example 4 except that the temperature in the spark plasma sintering method was 1900° C. The joint strength of the carbon member-inorganic member joined body E measured in the same manner as in Example 1 was 18 MPa. In the carbon member-inorganic member joined body E, strong joint between the carbon member and the inorganic member was achieved.

### Example 6

A carbon member-inorganic member joined body F was prepared in the same manner as in Example 4 except that the temperature in the spark plasma sintering method was 2000° C. The joint strength of the carbon member-inorganic member joined body F measured in the same manner as in Example 1 was 12 MPa. In the carbon member-inorganic member joined body F, strong joint between the carbon member and the inorganic member was achieved.

### Example 7

A carbon member-inorganic member joined body G was prepared in the same manner as in Example 1 except that the mass ratio between the inorganic material and the sintering aid was 97:2.5. The joint strength of the carbon member-inorganic member joined body G measured in the same manner as in Example 1 was 9 MPa. In the carbon member-inorganic member joined body G, strong joint between the carbon member and the inorganic member was achieved.

### Example 8

A carbon member-inorganic member joined body H was prepared in the same manner as in Example 1 except that the mass ratio between the inorganic material and the sintering aid was 90:10. The joint strength of the carbon member-inorganic member joined body H measured in the same manner as in Example 1 was 19 MPa. In the carbon member-inorganic member joined body H, strong joint between the carbon member and the inorganic member was achieved.

### Comparative Example 1

A laminate was joined by the spark plasma sintering method in the same manner as in Example 1 except that the sintering aid was not used, to prepare a carbon member-inorganic member joined body I.

The joint strength of the carbon member-inorganic member joined body I measured in the same manner as in Example 1 was 5 MPa. In the carbon member-inorganic member joined body I, joint strength between the carbon member and the inorganic member was small.

### Comparative Example 2

A laminate was joined by the spark plasma sintering method in the same manner as in Example 5 except that the sintering aid was not used, to prepare a carbon member-inorganic member joined body J.

The joint strength of the carbon member-inorganic member joined body J measured in the same manner as in Example 1 was 5 MPa. In the carbon member-inorganic member joined body J, joint strength between the carbon member and the inorganic member was small.

### Comparative Example 3

A carbon member-inorganic member joined body K was prepared in the same manner as in Comparative Example 1 except that the pressure by the spark plasma sintering method was 10 MPa. The joint strength of the carbon member-inorganic member joined body K measured in the same manner as in Example 1 was 3 MPa. In the carbon member-inorganic member joined body K, joint strength between the carbon member and the inorganic member was small.

### Comparative Example 4

A laminate was joined by the spark plasma sintering method in the same manner as in Example 6 except that the sintering aid was not used, to prepare a carbon member-inorganic member joined body L. The joint strength of the carbon member-inorganic member joined body L measured in the same manner as in Example 1 was 3 MPa. In the carbon member-inorganic member joined body L, joint strength between the carbon member and the inorganic member was small.

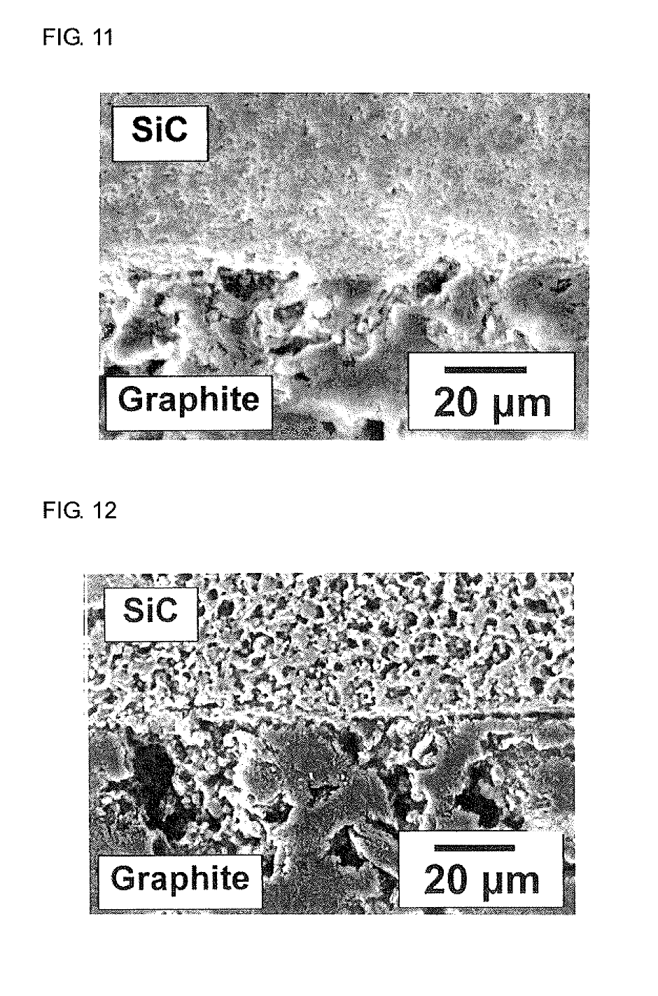

FIG. 11 and FIG. 12 respectively show a SEM image of the interface part between the carbon member and the inorganic member in Example 5 and in Comparative Example 2. In FIG. 11, no gap is observed in the joint part between the carbon member and the inorganic member, and it is understood that strong joint is achieved. On the contrary, in FIG. 12, a gap is observed in the joint part between the carbon member and the inorganic member, and it is understood that the joint is insufficient.

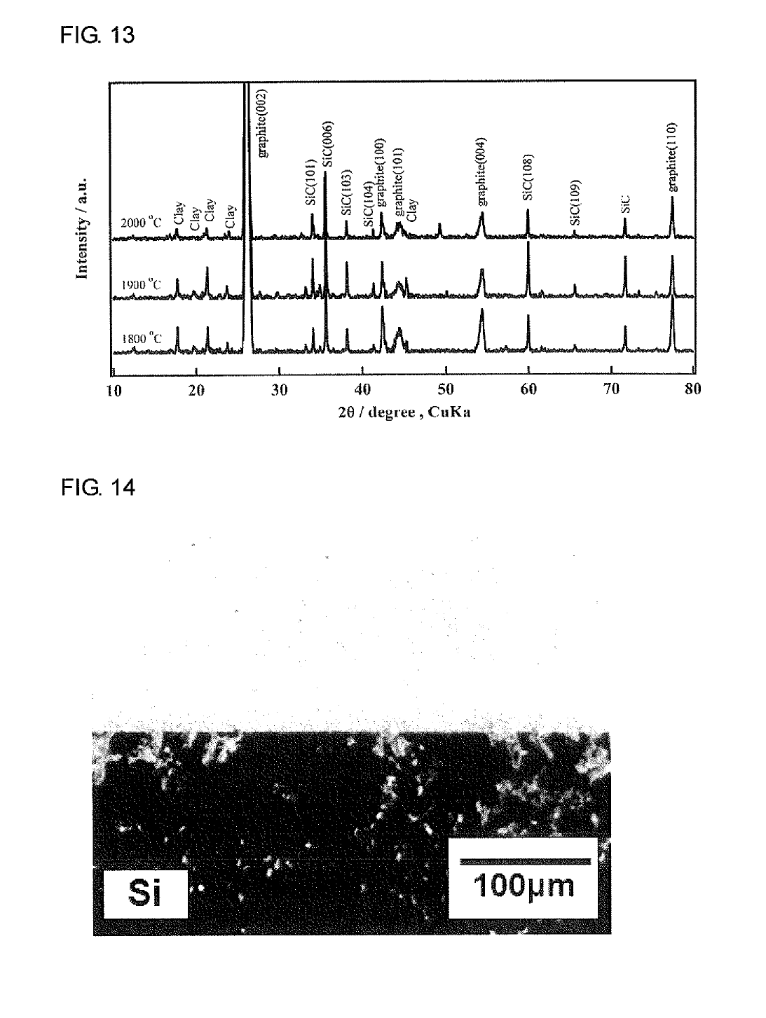

FIG. 13 is a graph showing peak intensity of X-ray diffraction of the interface part between the carbon member and the inorganic member in Examples 4 to 6. The sintering aid melts during sintering or firing, and oozes out into the joint part between the carbon member and the inorganic member, however, in FIG. 13, a peak of Al₂O₃ that is detected near 35° and 43° and a peak of Y₂O₃ that is detected near 29° and 49° are not observed. Also it is generally known that Si—Al—Y—O system phase is formed when Y₂O₃ or Al₂O₃ is added as a phase sintering aid to SiC and sintered, however, no crystal phase other than graphite and SiC is observed (a peak of clay used for immobilizing the sample is also observed). Therefore, a Si—Al—Y—O amorphous glass phase is formed in the interface part, and it is supposed that the strong joint strength is obtained because this amorphous glass phase allows the carbon member and the inorganic member to exert the anchor effect of cutting into irregularity portions in the surface of the carbon member while filling in a gap of the interface between the carbon member and the inorganic member.

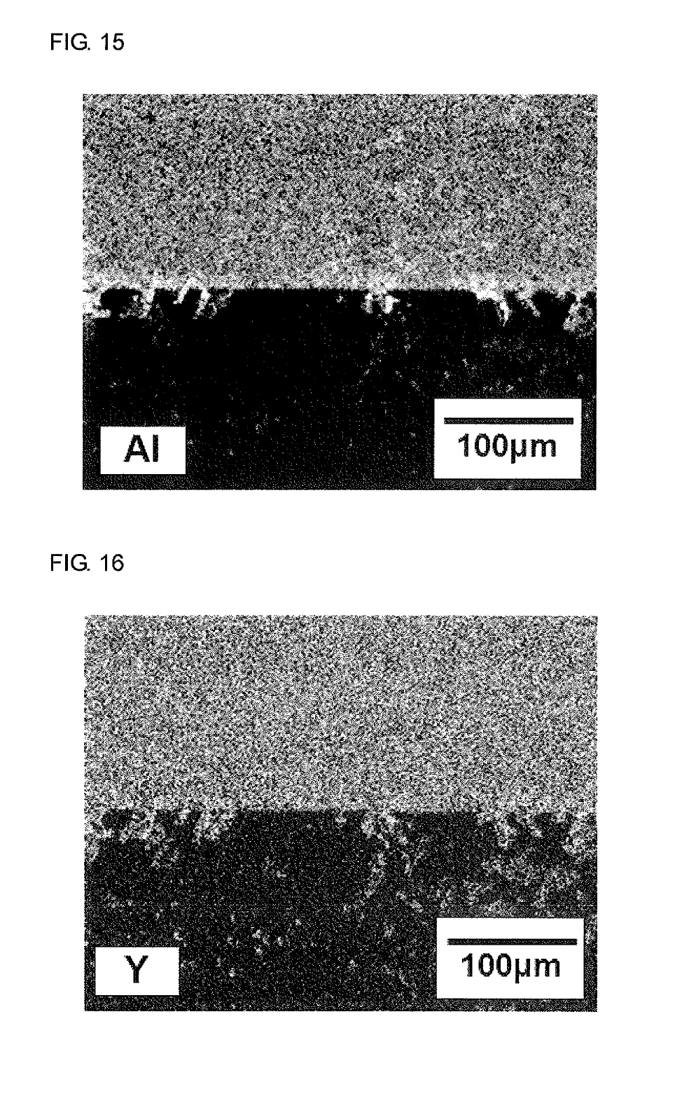

FIGS. 14 to 16 show SEM images showing distributions of Si, Al and Y elements in the interface part between the carbon member and the inorganic member in the carbon member-inorganic member joined body D obtained in Example 4. In Example 4, although it is understood that strong joint is achieved in the interface part, permeation of the sintering aid into the carbon member is not significantly observed, so that the aforementioned formation of the amorphous glass layer would contribute to the joint.

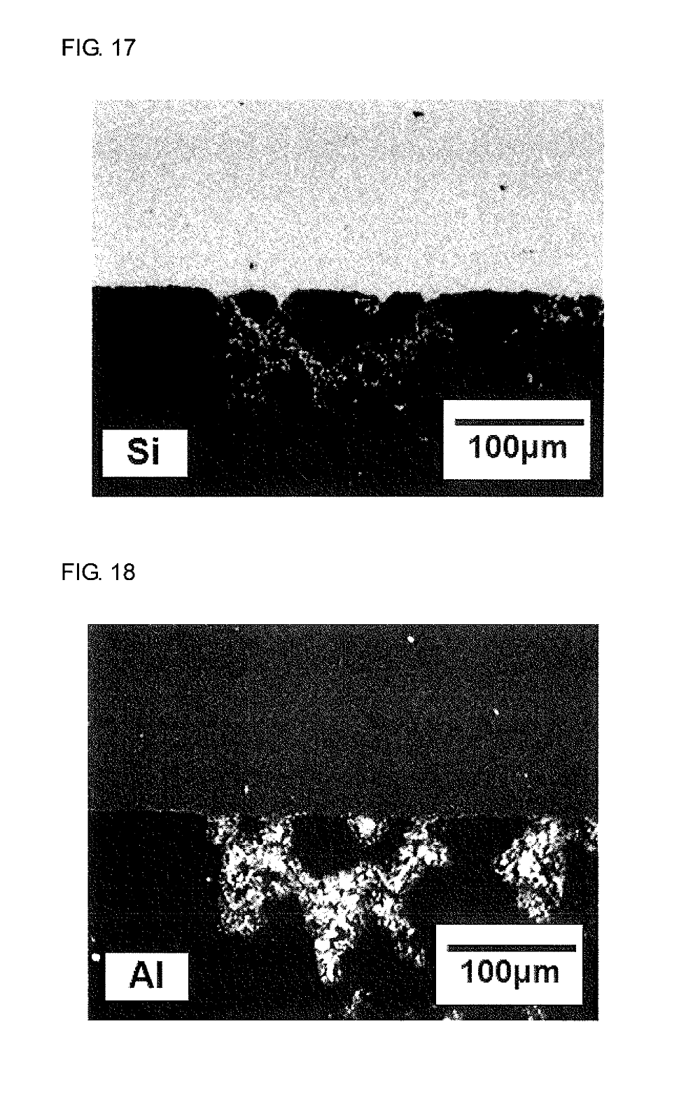

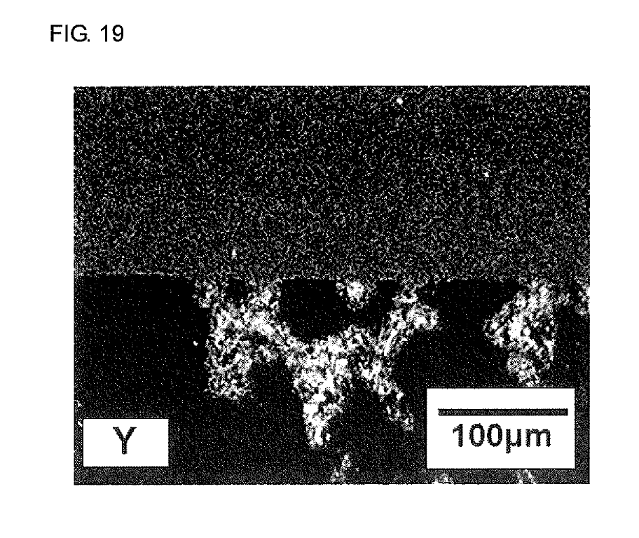

FIGS. 17 to 19 show SEM images showing distributions of Si, Al and Y elements in the interface part between the carbon member and the inorganic member in the carbon member-inorganic member joined body F obtained in Example 6. In Example 6, it is understood that strong joint is achieved in the interface part, and it is clear that the sintering aid permeates into the carbon member and there is plenty of sintering aid on the side of the carbon member.

What is claimed is:

1. A method for producing a carbon member-inorganic member joined body comprising a carbon member and an inorganic member joined together, wherein
the carbon member-inorganic member joined body is obtained by forming on the carbon member a layer containing an inorganic material and a sintering aid, and heating the layer.

2. The method for producing a carbon member-inorganic member joined body according to claim 1, wherein as the sintering aid, at least one kind selected from the group consisting of yttrium oxide, aluminum oxide, calcium oxide, lithium oxide, silicon oxide, boron oxide, zirconium oxide, magnesium oxide, cerium oxide, gadolinium oxide, europium oxide, lanthanum oxide, lutetium oxide, neodymium oxide, erbium oxide, dysprosium oxide and samarium oxide is used.

3. The method for producing a carbon member-inorganic member joined body according to claim 1, wherein the sintering aid is allowed to remain in a superficial layer of the carbon member by allowing the sintering aid to enter recesses or pores of the superficial layer of the carbon member by the heating, followed by cooling.

4. The method for producing a carbon member-inorganic member joined body according to claim 1, wherein silicon element is contained in the inorganic member and/or the sintering aid, and a crystal phase or an amorphous glass phase is formed in the interface between the carbon member and the inorganic member by the sintering.

5. The method for producing a carbon member-inorganic member joined body according to claim 1, wherein a content of the sintering aid in the layer containing the inorganic material and the sintering aid is greater than or equal to 2% by mass.

6. The method for producing a carbon member-inorganic member joined body according to claim 1, wherein as the inorganic material, at least one kind selected from the group consisting of a carbon material, a silicon material, a metal material and a glass material is used.

7. The method for producing a carbon member-inorganic member joined body according to claim 1, wherein as the carbon member, at least one kind selected from the group consisting of an electrode member for steelmaking, an isotropic graphite member, a porous carbon member, a carbon fiber assembly, a carbon fiber composite material, and a carbon fiber reinforced carbon composite material is used.

8. A carbon member-inorganic member joined body comprising:
a carbon member; and
an inorganic member joined with the carbon member, wherein
a sintering aid is contained both in a superficial layer on the side of the inorganic member in the carbon member and in a superficial layer on the side of the carbon member in the inorganic member.

9. The carbon member-inorganic member joined body according to claim 8, wherein a content of the sintering aid in the superficial layer on the side of the inorganic member in the carbon member is larger than that of the sintering aid on the side of the carbon member in the inorganic member.

10. A carbon member-inorganic member joined body comprising:
a carbon member; and
an inorganic member joined with the carbon member, wherein
a crystal phase or an amorphous glass phase formed by sintering is provided in joint interface between the carbon member and the ceramic member.
